(19) United States
(12) Patent Application Publication
(10) Pub. No.: US 2017/0016081 A1
(43) Pub. Date: Jan. 19, 2017

(54) OVERHEATING-INSENSITIVE FINE GRAINED ALLOY STEEL FOR USE IN DOUBLE HIGH-FREQUENCY HEAT TREATMENT AND METHOD OF MANUFACTURING THE SAME

(71) Applicant: Hyundai Motor Company, Seoul (KR)

(72) Inventor: Jae-Hee LEE, Yongin-si (KR)

(21) Appl. No.: 14/943,988

(22) Filed: Nov. 17, 2015

(30) Foreign Application Priority Data
Jul. 16, 2015 (KR) 10-2015-0100871

(51) Int. Cl. C21D 9/08; C22C 38/28; C22C 38/26; C22C 38/22; F16C 3/02; C22C 38/04; C22C 38/02; C21D 6/00; C21D 1/667; C21D 9/50; C22C 38/32; C22C 38/06

(52) U.S. Cl. CPC C21D 9/085; C22C 38/32; C22C 38/28; C22C 38/26; C22C 38/22; C22C 38/06; C22C 38/04; C22C 38/02; C21D 6/002; C21D 6/005; C21D 6/008; C21D 1/667; C21D 9/50; F16C 3/02

(57) ABSTRACT

A fine-grained alloy steel includes iron (Fe) as a main component, and 0.40 to 0.55% by weight of carbon (C), 0.20 to 0.40% by weight of silicon (Si), 0.8 to 1.0% by weight of manganese (Mn), 0.8 to 1.2% by weight of chromium (Cr), 0.045% by weight of aluminum (Al), and inevitable impurities, based on a total weight of the alloy steel.

### CROSS-REFERENCE TO RELATED APPLICATION

This application claims the benefit of priority to Korean Patent Application No. 10-2015-0100871, filed on Jul. 16, 2015 in the Korean Intellectual Property Office, the disclosure of which is incorporated herein by reference in its entirety.

### TECHNICAL FIELD

The present disclosure relates to an alloy steel used in a drive shaft for a vehicle and a method for manufacturing the same, and more particularly, to an overheating-insensitive fine-grained alloy steel for use in a double high-frequency heat treatment, in which an austenite grain size index is maintained and which is effective in improving strength and toughness, and a method for manufacturing the same.

### BACKGROUND

In recent years, a method of enhancing the efficiency of an internal combustion engine and a method of manufacturing a lightweight automobile have been developed to improve fuel consumption. Among such methods, the method of manufacturing the lightweight automobile is widely used to enhance the automobile fuel economy. However, vehicle strength and durability may be deteriorated in use of the above methods. Therefore, there exists a need in the automotive industry to solve these problems.

In the current automotive industry, technologies for eco-friendliness and energy saving by decreasing the vehicle weight for fuel economy have been developed. For example, hollow materials have been used to manufacture a vehicle part. However, the qualities of such hollow parts may vary relative to those of solid parts during a manufacturing process.

For example, a rod-shaped power transmission part such as a drive shaft for coupling a vehicle wheel to a final drive is manufactured by using a hollow material. However, during the manufacturing process of the drive shaft, brittleness of the drive shaft increases as grains grow and are coarsened upon overheating due to high-frequency heat treatment, resulting in cracking and damage to the drive shaft.

To solve the above problems, in a related art, an alloy steel of fine grained materials such as a highly strengthened alloy steel has been used as a material for the drive-shaft to ensure both strength and toughness of the alloy steel. For this, a heat treatment method for developing a fine-grained alloy steel and refining the grains has been developed. The fine-grained alloy steel is heat-treated at a high frequency to achieve refined grains and to prevent coarsening of the grains when the grains are heated at a temperature of 1,000° C. or higher, that is, overheated.

FIG. 1 is a cross-sectional view of a conventional drive shaft. The drive shaft has a rod-shaped part which couples vehicle wheels to a final drive unit to transmit power. In a suspension system, the drive shaft needs to freely move up and down since the final drive unit is fixed in a vehicle body while the wheels move independently.

As shown in FIG. 1, the drive shaft having a hollow shape includes a solid stub of which inner part is filled with an alloy steel, and a hollow tube of which inner part is empty. Although such a hollow drive shaft has been developed to improve fuel economy and reduce vehicle weight, the quality of the hollow drive shaft is interior compared to a solid drive shaft. Additionally, when a high-frequency heat treatment is performed at an overheating condition, that is, a temperature of 1,000° C. or higher, in a process of manufacturing the drive shaft, brittleness of an alloy steel may increase by coarsening of grains of the alloy steel, resulting in a cracked and damaged drive shaft.

FIG. 2 is an image of a conventional alloy steel taken under a transmission electron microscope (TEM). Generally, in the case of normal alloy steels, it can be seen that the grain size of the alloy steel is maintained at approximately 10 μm, as shown in FIG. 3. However, it can be seen that the grains of the alloy steel are coarsened when the alloy steel is overheated in the high frequency heat treatment process. The brittleness may increase due to such coarsening, and thus, the solid stub of the drive shaft or the hollow tube of the drive shaft is damaged. Therefore, the grains of the alloy steel which is used in the drive shaft for a vehicle need to be refined when the grains of the alloy steel are subjected to the high-frequency heat treatment to ensure safety and durability of the vehicle.

To solve the above problems, a method of strengthening the alloy steel has been applied, but fine-grained alloy steels needs to be also developed to ensure both strength and toughness of the alloy steel.

Accordingly, there exists a need to enhance rigidity of a drive shaft for a vehicle and improve durability of the drive shaft using an alloy steel having excellent strength and toughness, thereby improving quality of the vehicle. In addition, fuel economy can be improved by using a hollow vehicle part, and environmental pollution can be prevented with an increase in lifespan of the hollow vehicle part.

### SUMMARY

The present disclosure has been made in view of the above problems. An aspect of the present inventive concept provides a method of manufacturing a fine-grained alloy steel using a heat treatment method for developing a fine-grained alloy steel and refining grains. The fine-grained alloy steel includes iron (Fe) as a main component, and carbon (C), silicon (Si), manganese (Mn), chromium (Cr), molybdenum (Mo), aluminum (Al), titanium (Ti), niobium (Nb), boron (B), and inevitable impurities. Thus, the method is able to refine the grains after high-frequency heat treatment and also to prevent coarsening of the grains even when the grains are overheated.

Another aspect of the present inventive concept provides a drive shaft for a vehicle manufactured using a fine-grained alloy steel.

The technical aspects of the present inventive concept are not limited to the aforesaid, and other technical aspects not described herein will be clearly understood by those skilled in the art from the detailed description below.

According to an exemplary embodiment of the present inventive concept, a fine-grained alloy steel includes Fe as a main component, and 0.40 to 0.55% by weight of C, 0.20 to 0.40% by weight of Si, 0.8 to 1.0% by weight of Mn, 0.8 to 1.2% by weight of Cr, 0.045% by weight of Al, and inevitable impurities, based on a total weight of the fine-grained alloy steel.

The fine-grained alloy steel may further include molybdenum (Mo), in which Mo may be present at a content of 0.20 to 0.45% by weight based on the total weight of the alloy steel.

The fine-grained alloy steel may further include titanium (Ti), in which Ti may be present at a content of 0.030% by weight based on the total weight of the fine-grained alloy steel.

The fine-grained alloy steel may further include niobium (Nb), in which Nb may be present at a content of 0.025 to 0.05% by weight based on the total weight of the fine-grained alloy steel.

The fine-grained alloy steel may further include boron (B), in which B may be present at a content of 0.0020 to 0.0040% by weight based on the total weight of the fine-grained alloy steel.

The fine-grained alloy steel may further include Mo, Ti, Nb, and B, wherein Mo, Ti, Nb, and B may be present at a content of 0.20 to 0.45% by weight, a content of 0.030% by weight, a content of 0.025 to 0.05% by weight, and a content of 0.0020 to 0.0040% by weight, respectively, based on the total weight of the fine-grained alloy steel.

C, Si, Mn, Cr, Mo, Al, Ti, and Nb may have a refinement correlation index F of 8.5 to 12.

According to another exemplary embodiment of the present inventive concept, a method of manufacturing a fine-grained alloy steel includes mixing C, Si, Mn, Cr, Mo, Al, Ti, and Nb to prepare an alloy steel as a source material, heating the alloy steel, hot-forging the heated alloy steel, quenching and tempering the hot-forged alloy steel, and heat-treating the quenched and tempered alloy steel with a high frequency. C, Si, Mn, Cr, Mo, Al, Ti, and Nb have a refinement correlation index F of 8.5 to 12, as follows: F=10×[C]+0.33×[Si]+0.2×[Mn]+0.7×([Cr]+[Mo])+0.5×([Ti]+[Al]+[Nb]), where [C] is 0.54×(C content (% by weight)) where a content of C is greater than 0% by weight and less than or equal to 0.39% by weight, 0.115+0.268×(C content (% by weight))−0.038×(C content (% by weight))² where the C content is greater than 0.39% by weight and less than or equal to 0.55% by weight, 0.115+0.268×(C content (% by weight))−0.038×(C content (% by weight))² where the C content is greater than 0.55% by weight and less than or equal to 0.65% by weight, 0.143+0.2×(C content (% by weight)) where the C content is greater than 0.65% by weight and less than or equal to 0.75% by weight, and 0.062+0.409×(C content (% by weight))−0.135×(C content (% by weight))² where the C content is greater than 0.75% by weight and less than or equal to 0.9% by weight. [Si] is 1+0.7×(Si content (% by weight)) where a content of Si is greater than 0% by weight and less than or equal to 0.4% by weight. [Mn] is 1.3333+(Mn content (% by weight)) where a content of Mn is greater than 0% by weight and less than or equal to 0.8% by weight, where 3.3333×(Mn content (% by weight))+1 where the Mn content is greater than 0.8% by weight and less than or equal to 1.0% by weight, and 2.1×(Mn content (% by weight))−1.12 where the Mn content is greater than 1.0% by weight and less than or equal to 1.95% by weight. [Cr] is 1+2.16×(Cr content (% by weight)) where a content of Cr is greater than 0% by weight and less than or equal to 2.0% by weight. [Mo] is 1 where a content of Mo is greater than 0% by weight and less than 0.2% by weight, where 1+3×(Mo content (% by weight)) where the Mo content is greater than or equal to 0.2% by weight and less than or equal to 1.0% by weight. [Ti] is 145×(Ti content (% by weight)) where a content of Ti is greater than 0% by weight and less than or equal to 0.03% by weight, where 4.35 the Ti content is greater than 0.03% by weight. [Al] is 1.73×(Al content (% by weight)) where a content of Al is greater than 0% by weight and less than or equal to 0.05% by weight. [Nb] is 1+0.363×(Nb content (by weight)) where a content of Nb is greater than 0% by weight and less than or equal to 0.05% by weight.

The method may further include friction-welding the quenched and tempered fine-grained alloy steel after the step of quenching and tempering.

The step of quenching and tempering may include quenching the hot-forged fine-grained alloy steel with a first high frequency, quenching the hot-forged fine-grained alloy steel with a second high frequency, and tempering the hot-forged fine-grained alloy steel. The quenching with the first high frequency may be performed at a current of 310 A to 410 A, a voltage of 270 V to 370 V, and a frequency of greater than 0 kHz to 5 kHz, and the quenching with the second high frequency may be performed at a current of 310 A to 410 A, a voltage of 270 V to 370 V, and a frequency of 30 kHz to 50 kHz.

The tempering may be performed at a tempering holding temperature of 180° C. for a heat treatment time of 3 hours.

According to still another exemplary embodiment of the present inventive concept, a hollow drive shaft for a vehicle manufactured using a method of manufacturing a fine-grained alloy steel. The method includes mixing C, Si, Mn, Cr, Mo, Al, Ti, and Nb to prepare an alloy steel as a source material, heating the alloy steel, hot-forging the heated alloy steel, quenching and tempering the hot-forged alloy steel, and heat-treating the quenched and tempered alloy steel with a high frequency. C, Si, Mn, Cr, Mo, Al, Ti, and Nb have a refinement correlation index F of 8.5 to 12, as follows: F=10×[C]+0.33×[Si]+0.2×[Mn]+0.7×([Cr]+[Mo])+0.5×([Ti]+[Al]+[Nb]), where [C] is 0.54×(C content (% by weight)) where a content of C is greater than 0% by weight and less than or equal to 0.39% by weight, 0.115+0.268×(C content (% by weight))−0.038×(C content (% by weight))² where the C content is greater than 0.39% by weight and less than or equal to 0.55% by weight, 0.115+0.268×(C content (% by weight))−0.038×(C content (% by weight))² where the C content is greater than 0.55% by weight and less than or equal to 0.65% by weight, 0.143+0.2×(C content (% by weight)) where the C content is greater than 0.65% by weight and less than or equal to 0.75% by weight, and 0.062+0.409×(C content (% by weight))−0.135×(C content (% by weight))² where the C content is greater than 0.75% by weight and less than or equal to 0.9% by weight. [Si] is 1+0.7×(Si content (% by weight)) where a content of Si is greater than 0% by weight and less than or equal to 0.4% by weight. [Mn] is 1.3333+(Mn content (% by weight)) where a content of Mn is greater than 0% by weight and less than or equal to 0.8% by weight, where 3.3333×(Mn content (% by weight))+1 where the Mn content is greater than 0.8% by weight and less than or equal to 1.0% by weight, and 2.1×(Mn content (% by weight))−1.12 where the Mn content is greater than 1.0% by weight and less than or equal to 1.95% by weight. [Cr] is 1+2.16×(Cr content (% by weight)) where a content of Cr is greater than 0% by weight and less than or equal to 2.0% by weight. [Mo] is 1 where a content of Mo is greater than 0% by weight and less than 0.2% by weight, where 1+3×(Mo content (% by weight)) where the Mo content is greater than or equal to 0.2% by weight and less than or equal to 1.0% by weight. [Ti] is 145×(Ti content (% by weight)) where a content of Ti is greater than 0% by weight and less than or equal to 0.03% by weight, where 4.35 the Ti content is greater than 0.03% by weight. [Al] is 1.73×(Al content (% by weight)) where a content of Al is greater than 0% by weight and less than or equal to 0.05% by weight. [Nb] is 1+0.363×(Nb content (by weight)) where a content of Nb is greater than 0% by weight and less than or equal to 0.05% by weight

### BRIEF DESCRIPTION OF THE DRAWINGS

The above and other aspects, features and other advantages of the present inventive concept will be more clearly understood from the following detailed description taken in conjunction with the accompanying drawings.

FIG. 1 is a cross-sectional view of a conventional drive shaft for a vehicle.

FIG. 2 is a transmission electron microscope image of an alloy steel in which grains are coarsened after a conventional high-frequency treatment.

FIG. 3 is a transmission electron microscope image of an alloy steel in which grains are refined after the conventional high-frequency treatment.

FIG. 4 is a graph illustrating the amount of precipitates in a non-solid solution state according to temperature according to an exemplary embodiment of the present inventive concept.

FIG. 5 is a graph illustrating the grain size of an alloy steel according to a Mo content according to an exemplary embodiment of the present inventive concept.

FIG. 6 is a transmission electron microscope image of Mo carbides distributed at grain boundaries according to an exemplary embodiment of the present inventive concept.

FIG. 7 is a graph illustrating hardness of an alloy steel according to Cr content according to an exemplary embodiment of the present inventive concept

FIG. 8 is a graph illustrating hardness of an alloy steel according to Ti content according to an exemplary embodiment of the present inventive concept.

FIG. 9 is a graph illustrating results obtained by comparing torsional fatigue strengths of alloy steels of Examples in which upper and lower limits of respective alloy components according to an exemplary embodiment of the present inventive concept to a torsional fatigue strength of an alloy steel in which an excessive amount of respective alloy components are added.

FIG. 10 is a transmission electron microscope image of grains of an alloy steel, which is manufactured using a source material prepared from conventional alloy components, according to a heat treatment method according to an exemplary embodiment of the present inventive concept.

FIG. 11 is a transmission electron microscope image of a fine-grained alloy steel according to an exemplary embodiment of the present inventive concept.

FIG. 12 is a flowchart of a method of manufacturing a fine-grained alloy steel used in a drive shaft for a vehicle according to an exemplary embodiment of the present inventive concept.

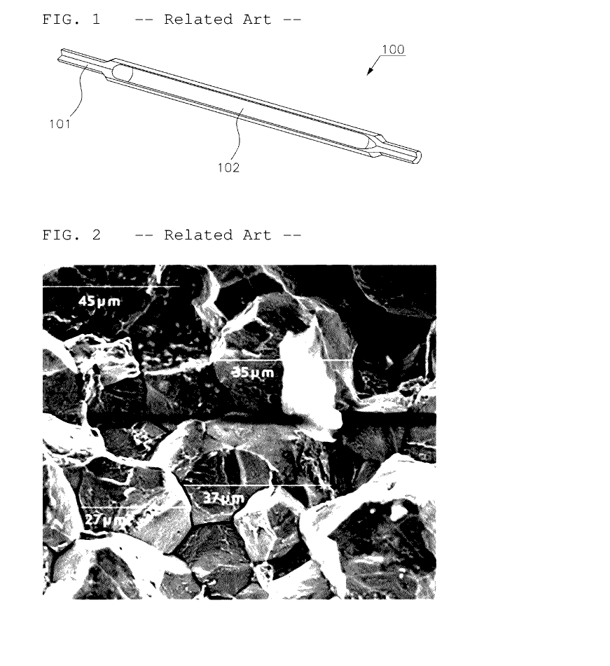

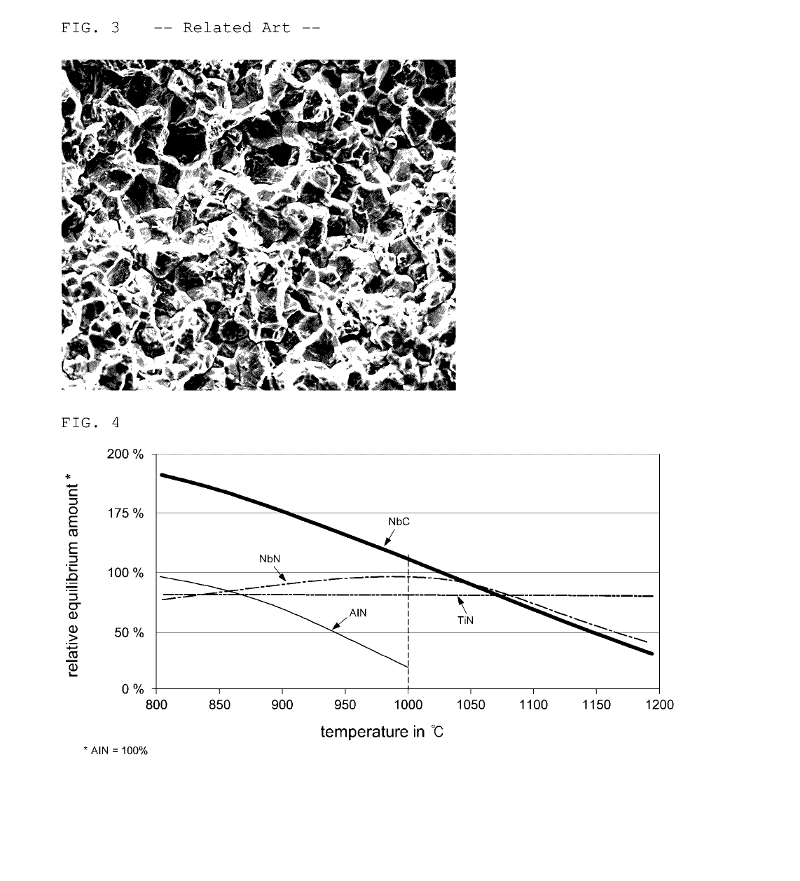

### DETAILED DESCRIPTION

Hereinafter, exemplary embodiments of the present inventive concept will be described in detail with reference to the accompanying drawings. Prior to the description, it should be understood that the terms used in the specification and appended claims should not be construed as limited to general and dictionary meanings, but interpreted based on the meanings and concepts corresponding to technical aspects of the present inventive concept on the basis of the principle that the inventor is allowed to define terms appropriately for best explanation. Therefore, the description given herein is merely an example for the purpose of illustrations only, not intended to limit the scope of the invention, so it should be understood that various other equivalents and modifications that can replace those at the time of filing this application could be made thereto without departing from the spirit and scope of the invention.

Reference will now be made in detail to the exemplary embodiments of the present inventive concept, examples of which are illustrated in the accompanying drawings. Wherever possible, the same reference numbers will be used throughout the drawings to refer to the same or like parts.

The present disclosure is directed toward vehicle parts subjected to a high-frequency heat treatment, such as a drive shaft, and toward refinement of grains of an alloy steel used in the vehicle parts by the high-frequency heat treatment of the alloy steel. The disclosure is further directed to prevention of the grains of the alloy steel from being coarsened even when the alloy steel is heat-treated at an overheating condition, that is, a temperature of 1,000° C. or higher. More specifically, the present disclosure is directed toward ultra-refinement of grains of the alloy steel through double high frequency quenching. Additionally, the present disclosure is directed toward the development of an alloy steel capable of preventing grains of the alloy steel from being coarsened even when quenching is continuously performed twice.

The present disclosure is designed to satisfy the above-described requirements, and thus is directed toward vehicle parts subjected to a high-frequency heat treatment, that is, an overheating-insensitive fine-grained alloy steel for use in a double high-frequency heat treatment for a drive shaft, and a method of manufacturing the same. According to one aspect, the present describes discloses an overheating-insensitive fine-grained alloy steel for use in a double high-frequency heat treatment.

The present disclosure is characterized in that alloy components, such as Ti and Nb, which may be maintained in a non-solid solution state even when the alloy components are overheated in a high-frequency heat treatment process, are added an alloy steel to prevent the alloy steel from being coarsened at a high temperature due to a grain boundary peening effect of precipitates. Mo and B are added to increase quenchability and grain refinement to ensure both strength and toughness of the alloy steel, and B is added to improve corrosion resistance.

Therefore, the alloy steel used for high-frequency heat treatment to manufacture vehicle parts according to an exemplary embodiment of the present inventive concept may include Fe as an main component, and 0.40 to 0.55% by weight of C, 0.20 to 0.40% by weight of Si, 0.8 to 1.0% by weight of Mn, 0.8 to 1.2% by weight of Cr, 0.045% by weight of Al, and inevitable impurities, based on the total weight of the alloy steel.

Additionally, the alloy steel according to an exemplary embodiment of the present inventive concept may be formed by selectively adding at least one selected from the group consisting of 0.20 to 0.45% by weight of Mo, 0.030% by weight of Ti, 0.025 to 0.05% by weight of Nb, and 0.0020 to 0.0040% by weight of B, when necessary.

In the fine-grained alloy steel developed according to the present disclosure, the contents of the alloy component, and a high-frequency heat treatment temperature and time are optimized to refine austenite grains through a high-frequency heat treatment and simultaneously prevent coarsening of the austenite grains and abnormal grain production, leading to refinement of austenite grains. Generally, strength of the alloy steel may be degraded when strength of the alloy steel is enhanced, but both strength and toughness of the alloy steel may be improved when the grains of the alloy steel are refined, thereby maximizing durability of the vehicle parts (the Hall-Petch effect).

In the fine-grained alloy steel according to an exemplary embodiment of the present inventive concept, components of the fine-grained alloy steel are selected using “refinement correlation index F.” The refinement correlation index F is an effective value when the alloy steel is overheated at 1,000° C. or higher. When the refinement correlation index F is 8.5<F<12, the alloy steel grain can be refined and coarsening of the grains can be prevented. In this case, as the refinement correlation index increases, superior effects such as strength and toughness of the alloy steel are realized. When the refinement correlation index is less than or equal to 8.5, a grain size of the alloy steel is approximately 30 μm, which makes it impossible to refine the grains of the alloy steel. When the refinement correlation index is greater than or equal to 12, an inclusion of the alloy steel may be impossible to handle, and fatigue strength may be remarkably degraded due to the presence of precipitates.

F=10×[C]+0.33×[Si]+0.2×[Mn]+0.7×([Cr]+[Mo])+0.5×([Ti]+[Al]+[Nb]) <Equation 1>

The refinement correlation index is shown in Equation 1. Equation 1 is an expression derived from the equation according to ASTM A 255-89, in which effects of various alloy components are presented as numerical values.

More specifically, the value of Equation 1 is as follows.

[C] represents 0.54×(C content (% by weight)) where a content of C is greater than 0% by weight and less than or equal to 0.39% by weight; 0.171+0.001×(C content (% by weight))+0.265×(C content (% by weight))² where the C content is greater than 0.39% by weight and less than or equal to 0.55% by weight; 0.115+0.268×(C content (% by weight))−0.038×(C content (% by weight))² where the C content is greater than 0.55% by weight and less than or equal to 0.65% by weight; 0.143+0.2×(C content (% by weight)) where the C content is greater than 0.65% by weight and less than or equal to 0.75% by weight; and 0.062+0.409×(C content (% by weight))−0.135×(C content (% by weight))² where the C content is greater than 0.75% by weight and less than or equal to 0.9% by weight.

[Si] represents 1+0.7×(Si content (% by weight)) where a content of Si is greater than 0% by weight and less than or equal to 0.4% by weight.

In addition, [Mn] represents 1.3333+(Mn content (% by weight)) where a content of Mn is greater than 0% by weight or less than or equal to 0.8% by weight; 3.3333×(Mn content (% by weight))+1 where the Mn content is greater than 0.8% by weight and less than or equal to 1.0% by weight; and 2.1×(Mn content (% by weight))−1.12 where the Mn content is greater than 1.0% by weight and less than or equal to 1.95% by weight.

Additionally, [Cr] represents 1+2.16×(Cr content (% by weight)) where a content of Cr is greater than 0% by weight and less than or equal to 2.0% by weight.

Additionally, [Mo] represents 1 where a content of Mo is greater than 0% by weight and less than 0.2% by weight; and 1+3×(Mo content (% by weight)) where the Mo content is greater than or equal to 0.2% by weight and less than or equal to 1.0% by weight.

In addition, [Ti] represents 145×(Ti content (% by weight)) where a content of Ti is greater than 0% by weight and less than or equal to 0.03% by weight; and 4.35 where the Ti content is greater than 0.03% by weight.

Additionally, [Al] represents 1.73×(Al content (% by weight)) where a content of Al is greater than 0% by weight and less than or equal to 0.05% by weight.

Further, [Nb] represents 1+0.363×(Nb content (% by weight)) where a content of Nb is greater than 0% by weight and less than or equal to 0.05% by weight.

More specifically, reasons for limiting numerical values of the components constituting the alloy steel according to an exemplary embodiment of the present inventive concept are as follows.

(1) C at 0.40 to 0.50% by Weight

Carbon (C) is the most potent interstitial matrix strengthening element in the chemical components, binds to an element such as Cr to form carbides, and thus improves strength and hardness and generates precipitated carbides.

To secure the same surface hardness as conventional materials after the high-frequency heat treatment, the C content may be in a range of approximately 0.40 to 0.50% by weight, based on the total weight of the alloy steel. When the C content is less than approximately 0.40% by weight, strength of the alloy steel may be degraded, and hardness of the alloy steel may not be ensured. In this case, a heat treatment effect may not be achieved at less than approximately 0.40% by weight since the high-frequency heat treatment is not effective for medium or high-carbon steels. When the C content is greater than approximately 0.50% by weight, the overall toughness of the alloy steel may be degraded due to an increase in core hardness of the alloy steel, cracks may occur after heat treatment, and welding quality upon welding with other parts may be influenced.

(2) Si at 0.2 to 0.4% by Weight

Silicon (Si) impedes carburizing when added in an excessive amount, and serves as a deoxidizing agent to inhibit formation of pinholes on the alloy steel. Si enhances strength of the alloy steel by a solid-solution strengthening effect, and enhances carbon activity, etc. as an inclusion. When the vehicle parts are driven, Si may be added to increase softening resistance so as to prevent degradation of hardness of a contact area caused due to increase in temperature.

To play such roles, the Si content may be in a range of approximately 0.20 to 0.40% by weight, based on the total weight of the alloy steel. When the Si content is less than approximately 0.20% by weight, Si has almost no effect as the deoxidizing agent, and hardness of the contact area may be degraded due to increase in temperature. When the Si content is greater than approximately 0.35% by weight, formability and carburizability may be degraded due to an excessive increase in solid-solution strengthening effect.

(3) Mn at 0.8 to 1.0% by Weight

Manganese (Mn) enhances quenchability of the alloy steel and improves hardenability of the alloy steel, thereby improving strength of the alloy steel, etc. When a vehicle part having a relatively thick thickness is mass-produced, Mn secures durability of the alloy steel. An Mn content may be in a range of approximately 0.8 to 1.0% by weight.

When the Mn content is less than approximately 0.8% by weight, sufficient strength may not be secured. When the Mn content is greater than approximately 1.0% by weight, grain boundary oxidation may occur, and mechanical properties of the alloy steel may be degraded.

(4) Cr at 0.8 to 1.2% by Weight

Chromium (Cr) enhances quenchability of the alloy steel, refines a structure of the alloy steel while imparting hardenability, and spheroidizes grains through heat treatment. Additionally, Cr serves to forge lamellas in cementite, improve an annealing property, and enhance wear resistance due to formation of carbides.

A Cr content may be in a range of 0.8 to 1.2% by weight. Here, when the Cr content is less than 0.8% by weight, quenchability and hardenability may be restricted, sufficient grain refinement and spheroidization of a structure may not be obtained, and annealing may be difficult. When the Cr content is greater than 1.2% by weight, toughness and machinability may be degraded, and effects according to an increase in strength may be insignificant, resulting in an increase in manufacturing costs.

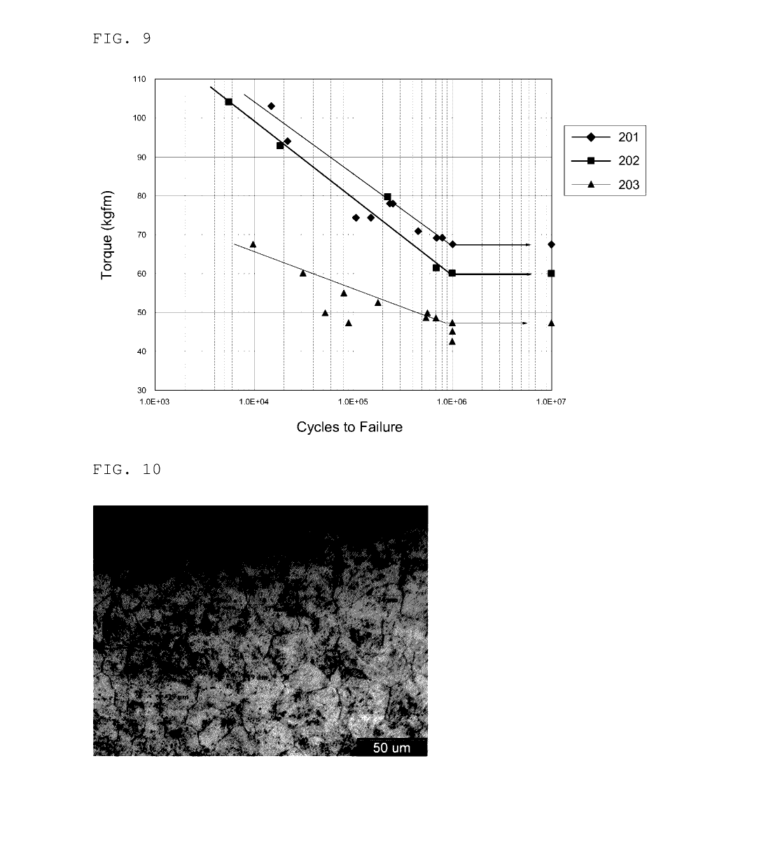

FIG. 7 is a graph illustrating hardness of an alloy steel according to a Cr content. As shown in the graph of FIG. 7, the strength of the alloy steel increases as the Cr content of the alloy steel increases. However, since an increase in the Cr content leads to an increase in manufacturing costs, the Cr content is limited to 1.2% by weight or less.

(5) Mo at 0.20 to 0.45% by Weight

Molybdenum (Mo) enhances quenchability of the alloy steel, and thus, improves hardenability and toughness of the alloy steel after tempering, and imparts brittleness resistance. Additionally, Mo reduces carbon activity. Further, Mo inhibits the growth of grains as Mo carbides are precipitated at austenite grain boundaries and form a fully bainitic structure like boron (B) so as to refine the grains.

A Mo content may be in a range of approximately 0.20 to 0.45% by weight. When the Mo content is less than approximately 0.20% by weight, sufficient hardenability and toughness of the alloy steel may not be secured, and a refinement effect may not be shown. When the Mo content is greater than approximately 0.45% by weight, toughness, machinability (i.e., processability), and productivity of the alloy steel may be degraded, and effects according to an increase in content may be insignificant, resulting in an increase in manufacturing costs.

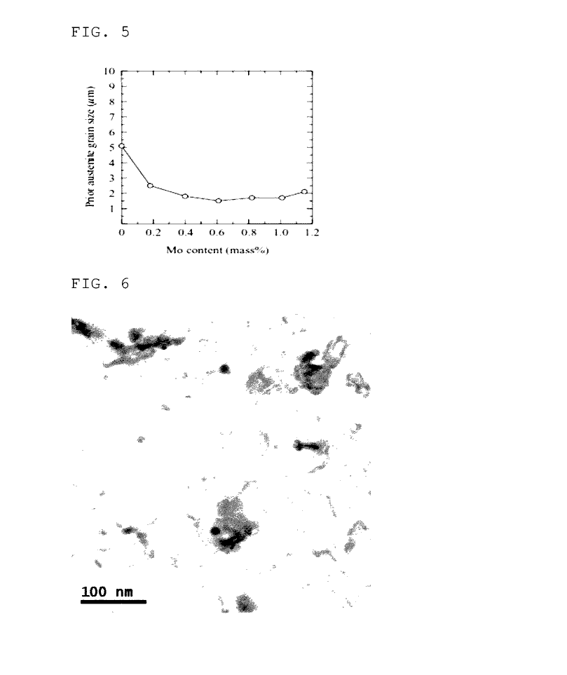

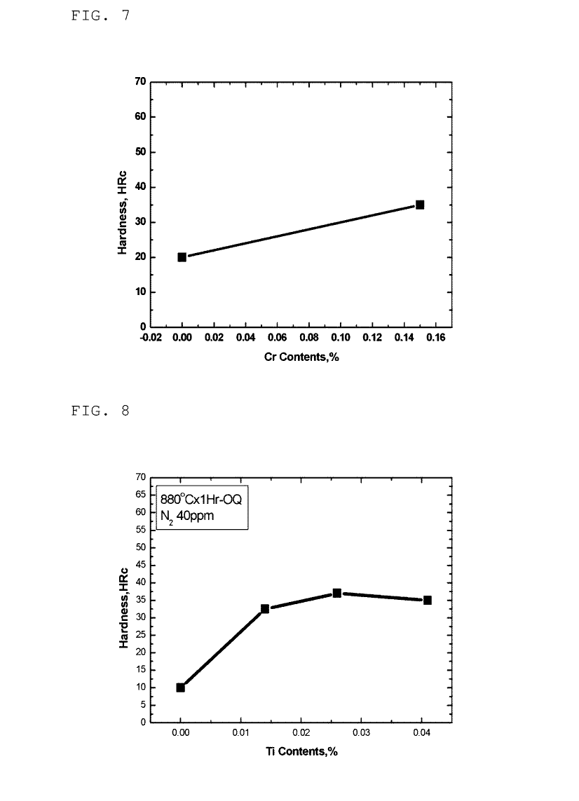

FIG. 5 is a graph illustrating a grain size of an alloy steel according to a Mo content added to the alloy steel. FIG. 5 shows the grain size only when the Mo content is greater than or equal to approximately 0.20% by weight. However, it can be seen that effects on the grain size are insignificant when Mo is added at a content of approximately 0.20% by weight or more. FIG. 6 is a transmission electron microscope image of Mo carbides distributed at grain boundaries. It can be seen that Mo carbides are formed when Mo is added to the alloy steel.

(6) B at 0.0020 to 0.0040% by Weight

Boron (B) improves hardenability, tensile strength, impact resistance, and strength of alloy steel, and prevents corrosion of the alloy steel. Additionally, B transforms the structure into bainite before a high-frequency heat treatment and promotes the high-frequency heat treatment due to an increase in quenchability. The bainitic structure has a ferrite/cementite structure as a fine acicular structure. Here, fine grain boundaries serve as nucleation sites upon the high-frequency heat treatment to increase the number of grains, thus refining grains. However, weldabillty may be degraded.

For this purpose, a B content may be in a range of approximately 0.0020 to 0.0040% by weight. When the B content is less than approximately 0.0020% by weight, it is difficult to secure sufficient hardenability of the alloy steel. When the B content is greater than approximately 0.004% by weight, toughness and ductility of the alloy steel may be degraded, thus degrading impact resistance of the alloy steel. As a result, durability of the alloy steel may be degraded due to segregation.

(7) Al at 0.045% by Weight

Aluminum (Al) is a potent deoxidizing agent and improves cleanliness of alloy steel as well as refines grains.

A content of Al may be approximately 0.045% by weight. When the Al content is less than 0.045% by weight, it may be difficult to achieve a sufficient effect as the deoxidizing agent, and sufficient effects associated with cleanliness and grain refinement. When the Al content is greater than 0.045% by weight, coarse oxide inclusions and the like may be formed, which results in a decrease in fatigue life of steel.

(8) Ti at 0.030% by Weight

Titanium (Ti) inhibits the growth of grains and improves high-temperature stability, strength, and toughness of alloy steel.

A Ti content may be 0.030% by weight. When the Ti content is greater than approximately 0.030% by weight, coarse precipitates may be formed, and manufacturing costs may be increased by reduction in low-temperature impact resistance and saturation. When the Ti content is less than approximately 0.030% by weight, high-temperature stability may not be improved.

FIG. 8 is a graph illustrating hardness of an alloy steel according to increase in a Ti content. As shown in FIG. 8, hardness is enhanced as the Ti content increases, but the hardness reaches the maximum value when the Ti content is 0.030% by weight. Therefore, the Ti content in the fine-grained alloy steel may be 0.03% in the present disclosure.

(9) Nb at 0.025 to 0.05% by Weight

Niobium (Nb) refines grains, raises a recrystallization temperature, and improves hardenability and toughness of alloy steel. Here, a content of Nb may be in a range of approximately 0.025 to 0.05% by weight.

When the Nb content is greater than approximately 0.05% by weight, Nb may be saturated and toughness, machinability, and productivity of the alloy steel may also be degraded. When the Nb content is greater than approximately 0.025% by weight, the alloy steel has no effect in refining grains.

The components Nb, Al, and Ti are added in small amounts to prevent coarsening of a fine grained structure in the alloy steel. The order of the components of the alloy steel, which remain in the form of precipitates without being dissolved at high temperatures, is Nb, Al, and Ti. According to the Cuddy equation of saturation, Ti, Al, and Nb remain in the form of precipitates without being dissolved at approximately 1,200° C., approximately 1,050° C., and approximately 1,000° C., respectively, thus preventing coarsening of grains due to a grain boundary peening effect.

TABLE 1

| | Grain coarsening | |
|---|---|---|
| Items | temperature (Tc) | Note |
| Ti | 1,198° C. | *Based on Cuddy's equation |
| Al | 1,034° C. | Tc = A + B[Q/F − log(MX)] − 273 |
| Nb | 1,005° C. | M: (Amount of alloy) % |
| | | X: (carbon, or nitrogen) % |
| | | A, B, Q, F: constants |

The grain coarsening temperatures (GCTs), that is, Tc, of the alloy components are listed in Table 1 above. Ti, Al, and Nb may be maintained in a non-solid solution state at 1,000° C. with the order of the components presented herein. That is, the coarsening of the grains upon overheating may be prevented due to a grain boundary peening effect. FIG. 4 is a graph illustrating the precipitates in a non-solid solution state according to a grain coarsening temperature as listed in Table 1. As shown in FIG. 4, precipitates in a non-solid solution state as NbC and AlN are reduced with an increasing temperature, but TiN and NbN are maintained at certain levels so that the precipitates in the non-solid solution state remain to an extent to which grain refinement of the alloy steel is maintained at a temperature of 1,000° C. However, when such components of the alloy steel are added in large amounts, machinability may be poor, and the alloy components may serve as inclusions when the precipitates are coarsened. Therefore, the amounts of the alloy components have to be restricted.

The alloy steel according to an exemplary embodiment of the present inventive concept has excellent yield strength, tensile strength, impact strength, durability, and the like, and thus, may be applied to parts for high-frequency heat treatment. In particular, the alloy steel may be applied to a drive shaft for a vehicle.

According to another embodiment of the present inventive concept, a method of manufacturing an overheating-insensitive fine-grained alloy steel is used for a double high-frequency heat treatment.

The overheating-insensitive fine-grained alloy steel for use in double high-frequency heat treatment according to an exemplary embodiment of the present inventive concept may be properly manufactured with reference to known techniques, as apparent to those skilled in the art.

FIG. 12 is a flowchart of a method of manufacturing an overheating-insensitive fine-grained alloy steel for a double high-frequency heat treatment. A method of manufacturing a fine-grained alloy steel used to manufacture a drive shaft for a vehicle according to an exemplary embodiment of the present inventive concept includes mixing a material of the alloy steel to prepare an alloy steel as a source material (S10), heating the alloy steel (S20), hot-forging the heated alloy steel (S30), quenching and tempering the hot-forged alloy steel (S40), friction-welding the quenched and tempered alloy steel (S50), and heat-treating the friction-welded alloy steel with high frequency (S60).

The step of mixing and preparing (S10) may include adding at least one element selected from the group consisting of C, Si, Mn, Cr, Al, Mo, Ti, Nb, and B, and mixing the element with the material of the alloy steel, as described above. The alloy component may be added to the materials to refine grains of the alloy steel. As a result, yield strength, tensile strength, impact strength, durability, and torsional strength of the material may be improved.

The step of heating (S20) and the step of hot forging (S30) include heating the alloy steel using a conventional method, and preparing a drive shaft in a desired shape by forging.

Additionally, the step of friction welding (S50) and the step of heat treatment (S60) include a heat treatment using a conventional method, and connecting respective parts.

In addition, the step of quenching and tempering (S40) includes quenching the hot-forged alloy steel with high frequency under certain conditions, unlike the prior art. To satisfy this requirement, a parameter, that is, refinement correlation index F of Equation 1, is used as the standard for determining whether the grains of the alloy steel exhibit a grain refinement effect by high-frequency quenching. This value of the parameter varies according to the component ratios of elements of an alloy, and is effective in controlling the quality of the alloy steel to prevent the production of inferior products. When the high-frequency heat treatment process is optimized using the refinement correlation index F, impact strength, torsional strength, and durability of the alloy steel may be improved, compared to the conventional alloy steel.

More specifically, in the present disclosure, the step of quenching and tempering (S40) includes quenching the hot-forged alloy steel with a first high frequency (S41), quenching the hot-forged alloy steel with a second high frequency (S42), and tempering the hot-forged alloy steel (S43). In the present disclosure, the step of quenching with the first high frequency (S41) may be performed to determine whether a structure of the alloy steel is homogenized, that is, a tempering effect. Here, the refinement of grains of the alloy steel is maximized in the quenching with the second high frequency. The step of quenching with the second high frequency (S42) refines the grains by the heat treatment for a short period of time as highly refining the grains of the alloy steel.

TABLE 2

| Items | | First (S41) | Second (S42) |
|---|---|---|---|
| High-frequency | Current (A) | 310 to 410 | 310 to 410 |
| quenching | Voltage (V) | 270 to 370 | 270 to 370 |
| | Frequency | 5 or less | 30 to 50 |
| | (Khz) | | |
| Tempering | Maintenance | 180° C., and 3 hours | |
| (S43) | temperature | | |
| | and time | | |

The conditions for the quenching with the first high frequency and the quenching with the second high frequency are listed in Table 2. In the conditions for quenching with the first high frequency and quenching with the second high frequency, the same current of 310 to 410 A, and the same voltage of 270 to 370 V are used. However, the heat treatment with the first high frequency includes applying a high frequency of 5 Hz or less to the alloy steel, and the heat treatment with the second high frequency includes applying a high frequency of 30 to 50 Hz to the alloy steel. Additionally, the conditions for tempering include a maintenance temperature of 180° C., and a maintenance time of 3 hours.

### Examples

Hereinafter, the present disclosure will be described in further detail as an example. It will be apparent to those skilled in the art to which the present disclosure pertains that the detailed description presented herein is given by way of example only and is not intended to limit the present disclosure.

TABLE 3

| | Components of alloy steel | | | | | | | | |
|---|---|---|---|---|---|---|---|---|---|
| | C | Si | Mn | Cr | Mo | Al | Ti | Nb | B |
| Comparative | 0.4 | 0.2 | 0.75 | 0.1 | — | — | — | — | — |
| Example 1 | | | | | | | | | |
| (carbon | | | | | | | | | |
| steel) | | | | | | | | | |
| Comparative | 0.4 | 0.2 | 0.7 | 1 | — | — | — | — | — |
| Example 2 | | | | | | | | | |
| Comparative | 0.4 | 0.25 | 0.85 | 1 | 0.15 | 0.025 | — | — | — |
| Example 3 | | | | | | | | | |
| Comparative | 0.4 | 0.4 | 1 | 2 | 1 | 0.045 | 0.3 | 0.05 | 0.04 |
| Example 4 | | | | | | | | | |
| Example 1 | 0.4 | 0.2 | 0.8 | 0.8 | 0.2 | 0.045 | 0.3 | 0.025 | 0.002 |
| (lower | | | | | | | | | |
| limit) | | | | | | | | | |
| Example 2 | 0.55 | 0.4 | 1 | 1.2 | 0.45 | 0.045 | 0.3 | 0.05 | 0.004 |
| (upper | | | | | | | | | |
| limit) | | | | | | | | | |

For comparison, the components of the alloy steels of Examples and conventional alloy steels are listed in Table 3. To verify the effects of the present disclosure, a carbon steel of Comparative Example 1 to which the components of the alloy steel were hardly added, a carbon steel of Comparative Example 2 in which Cr was present at a high content, a carbon steel of Comparative Example 3 in which Cr and Mo were present at a high content, a carbon steel of Comparative Example 4 in which Cr, Mo, and B among the components of the alloy steel according to the present disclosure were added at a content exceeding upper limit thereof. A carbon steel of Example 1 includes lower limits of the components of the alloy steel according to the present disclosure, and a carbon steel of Example 1 includes the upper limits of the components of the alloy steel according to the present disclosure were compared. The coefficients and refinement correlation indexes of the respective components are listed in the following Table 4.

TABLE 4

| | | | | | | | | | Refinement | Grain |
|---|---|---|---|---|---|---|---|---|---|---|
| Component | | | | | | | | | correlation | size after |
| coefficient | [S] | [Si] | [Mn] | [Cr] | [Mo] | [Al] | [Ti] | [Nb] | index (F) | overheating |
| Comparative | 0.214 | 1.140 | 2.083 | 1.216 | 1.000 | 0.000 | 0.000 | 0.000 | 4.482 | AGS#7 |
| Example 1 | | | | | | | | | | |
| Comparative | 0.214 | 1.140 | 2.083 | 3.160 | 1.000 | 0.000 | 0.000 | 0.000 | 5.833 | AGS#7 |
| Example 2 | | | | | | | | | | |
| Comparative | 0.214 | 1.175 | 3.833 | 3.160 | 1.000 | 0.043 | 0.000 | 0.000 | 6.226 | AGS#7 |
| Example 3 | | | | | | | | | | |
| Comparative | 0.214 | 1.280 | 4.333 | 5.320 | 4.000 | 0.078 | 4.350 | 1.815 | 13.072 | AGS#13 |
| Example 4 | | | | | | | | | | |
| Example 1 | 0.214 | 1.140 | 3.667 | 2.728 | 1.600 | 0.078 | 4.350 | 0.908 | 8.945 | AGS#11 |
| Example 2 | 0.252 | 1.280 | 4.333 | 3.597 | 2.350 | 0.078 | 4.350 | 1.815 | 11.087 | AGS#12 |

In Table 4, the AGS index refers to a grain size. For the AGS index, the average size of the grains of the alloy steel decreases as a value of the AGS index increases.

TABLE 5

| AGS index | Average grain size (mm) |
|---|---|
| −7 | 4 |
| −6 | 2.828 |
| −5 | 2 |
| −4 | 1.414 |
| −3 | 1 |
| −2 | 0.707 |
| −1 | 0.5 |
| 0 | 0.354 |
| 1 | 0.25 |
| 2 | 0.177 |
| 3 | 0.125 |
| 4 | 0.0884 |
| 5 | 0.0625 |
| 6 | 0.0442 |
| 7 | 0.0312 |
| 8 | 0.221 |
| 9 | 0.0156 |
| 10 | 0.011 |
| 11 | 0.0078 |
| 12 | 0.0055 |
| 13 | 0.0039 |
| 14 | 0.0028 |
| 15 | 0.002 |
| 16 | 0.0014 |
| 17 | 0.001 |

Table 5 lists data on grain sizes of ferrite and austenite grains of alloy steels, as measured according to KS D 0205. As listed in Table 5, it could be seen that the average grain size of the grains is decreased as the AGS index is increased. Based on the results listed in Table 5, when the grain sizes of the alloy steels after the alloy steels were overheated at a high temperature were compared to the refinement correlation indexes F listed in Table 4, it could be seen that the carbon steels of Comparative Examples 1 to 3 had a refinement correlation index between approximately 4 to 7, and thus, the average grain size after the alloy steel was overheated at the high temperature was approximately 30 μm since the alloy steel had an AGS index of 7. However, it could be seen that the carbon steels of Comparative Example 4, and Examples 1 and 2 had a refinement correlation index of approximately 9 to 13, and thus, the average grain size after the alloy steel was overheated at the high temperature was in a range of approximately 3.9 to 7.8 μm since the alloy steel had an AGS index of 11 to 13. Therefore, it could be seen that the grains were further refined as the refinement correlation index F increased. That is, when the average grain size after the alloy steel was overheated at 900° C. or higher was determined, it could be seen that the conventional carbon steels of Comparative Examples 1 to 4 unexpectedly have a refinement correlation index F of 8.5 or less had a similar average grain size of approximately 30 μm (i.e., an AGS index of 7), and the average grain size is decreased as the refinement correlation index F is increased. Torsional fatigue strength was unexpectedly reduced due to the presence of coarse precipitates when the refinement correlation index F was greater than or equal to 12, as described above.

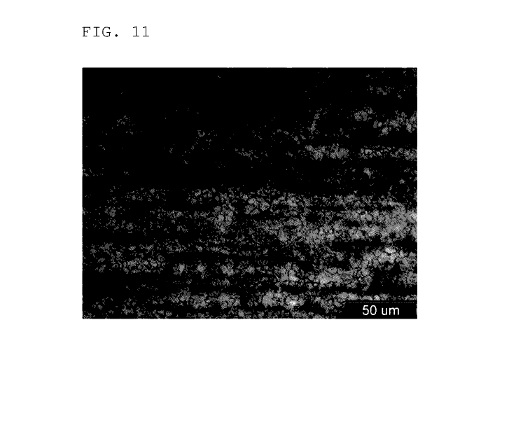

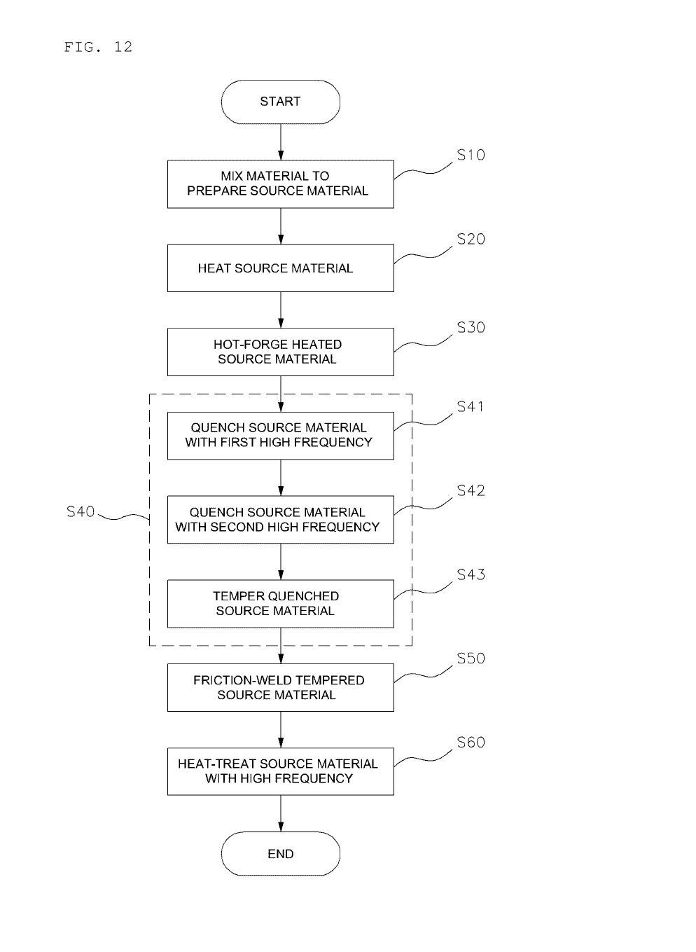

FIG. 9 is a graph illustrating the results obtained by comparing the torsional fatigue strengths of the alloy steels of Comparative Example 4 and Examples 1 and 2, all of which had a refinement correlation index F of 8.5 or more. Referring to the torsional fatigue strengths as shown in FIG. 9, the torsional fatigue strength of the carbon steel 203 of Comparative Example 4 was unexpectedly approximately 25% lower than those of the carbon steels 202 and 203 of Examples 1 and 2. As a result, when the components of the alloy steel were added in an excessive amount so that the refinement correlation index F was greater than or equal to 12, the torsional fatigue strength of the alloy steel was unexpectedly reduced even when the material of the alloy steel was further refined, and thus, the alloy steel was not suitable as the alloy steel for use in the drive shaft for a vehicle. Therefore, the refinement correlation index in a range of 8.5 to 12 was desirable.

Accordingly, when the fine-grained alloy steel according to the present disclosure and the method of manufacturing the same were implemented, both strength and toughness of the alloy steel were unexpectedly improved through grain refinement. It was unexpectedly possible to refine the grains of the alloy steel even when the alloy steel was overheated in a heat treatment process, and the strength of the alloy steel was unexpectedly improved without increase in hardness. As a result, machinability and durability of the alloy steel were secured at the same time. Additionally, it was apparent to those skilled in the art that the strength and elongation of the material were unexpectedly improved as the grains of the alloy steel were further refined due to the Hall-Petch effect. Therefore, the above-described carbon steels of Comparative Example 3 and Example 2 were compared to evaluate physical properties. The results are listed in the following Table 6.

TABLE 6

| | Yield | Tensile | | Impact |
|---|---|---|---|---|
| | strength | strength | Elongation | strength |
| Items | (MPa) | (MPa) | (%) | (J/cm²) |
| Comparative | 834 | 980 | 12 | 59 |
| Example 3 plus | | | | |
| inventive high- | | | | |
| frequency | | | | |
| quenching | | | | |
| Example 2 | 855 | 1,219 | 16.4 | 105 |

As shown in Table 6, the heat treatment with a high frequency of the present disclosure was further performed in Comparative Example 3. When the results were compared to those of Example 2, the carbon steels had a similar yield strength, but tensile strength, elongation, and impact strength of the carbon steel of Example 2 were unexpectedly increased by approximately 24.4%, 36.7%, and 78.0%, respectively.

Further, it could be seen that, as the conventional carbon steels of Comparative Examples 1 to 4 were subjected to quenching with first high frequency and quenching with second high frequency, the grains of the conventional carbon steels were unexpectedly coarsened, that is, the average grain size was approximately 30 μm (i.e., an AGS index of 7). FIG. 10 is a transmission electron microscope image of grains of the conventional carbon steels of Comparative Examples 1 to 4 which were subjected to quenching with a first high frequency and quenching with a second high frequency. Here, it could be seen that the grains of the alloy steel of Example 2 of the present disclosure having a grain size of 30 μm (i.e., an AGS index of 7) were refined to approximately 5 μm (i.e., an AGS index of 12), and thus the strength, elongation, and impact strength of the alloy steel were all unexpectedly enhanced.

According to yet another embodiment, the present inventive concept provides a hollow drive shaft for a vehicle, in which the hollow drive shaft is manufactured using an overheating-insensitive fine-grained alloy steel for a double high-frequency heat treatment and the method of manufacturing the same.

TABLE 7

| Items | Objective | Tester name |
|---|---|---|
| Static torsional | Evaluation of static | Torsional |
| fracture strength | torsional fracture | endurance/static |
| test | strength | strength testing |
| Torsional fatigue | Evaluation of | machine (MTS Systems |
| endurance test | torsional fatigue | Corporation) |
| | endurance | |
| | performance | |

Table 7 is a chart illustrating a testing machine and experimental contents used to test a hollow drive shaft for a vehicle, in which the drive shaft is manufactured using the overheating-insensitive fine-grained alloy steel for use in double high-frequency heat treatment according to the present disclosure and the method of manufacturing the same. A static torsional fracture strength test for evaluating a static torsional fracture strength of the alloy steel, and a torsional fatigue endurance test for evaluating torsional fatigue endurance performance of the alloy steel were carried out using a torsional endurance/static strength testing machine manufactured by MTS Systems Corporation.

TABLE 8

| | Torsional fatigue | Static torsional |
|---|---|---|
| | endurance [cyc] (test | fracture |
| Items | load: 3,412 Nm) | strength [Nm] |
| Comparative Example | 280,000 on average | 4,660 |
| 3 | | |
| Example 1 | Damaged at 500,000 | 6,800 |
| | Damaged at 620,000 | |
| | Forcibly stopped over | |
| | 1,000,000 | |

From the results listed in Table 8, it could be seen that, when the hollow drive shaft for a vehicle was manufactured, in which the drive shaft is manufactured using the overheating-insensitive fine-grained alloy steel for use in the double high-frequency heat treatment according to the present disclosure and the method of manufacturing the same, and a torsional fatigue endurance test and a static torsional fracture strength test were performed on the hollow drive shaft for a vehicle to compare the alloy steel of Example 2 of the present disclosure to the alloy steel of Comparative Example 3, the torsional fatigue endurance performance was unexpectedly improved by at least 78.6% and the static torsional fracture strength was also unexpectedly improved by 45.9%. Therefore, it could be seen that the alloy steel of the present disclosure had unexpectedly superior durability impact strength and fracture strength to the conventional alloy steels.

According to the fine-grained alloy steel including Fe as an main component, and C, Si, Mn, Cr, Mo, Al, Ti, Nb, B, and inevitable impurities, and the method of manufacturing the same, the fine-grained alloy steel used to manufacture the drive shaft for a vehicle according to the present disclosure can be useful in improving durability due to an increase in quenchability since the grains are refined after high-frequency heat treatment and the coarsening of the grains is prevented even when the grains are overheated in a high-frequency heat treatment process, also useful in improving durability due to increase in strength, toughness and corrosion resistance of the material since the grains are refined. Additionally, the hollow drive shaft using the fine-grained alloy steel according to the present disclosure has improved durability and strength with improvement of torsional fatigue endurance performance and static torsional fracture strength.

According to the fine-grained alloy steel including Fe as an main component, and C, Si, Mn, Cr, Mo, Al, Ti, Nb, B, and inevitable impurities, and the method of manufacturing the same, the alloy steel used to manufacture the drive shaft for a vehicle according to the present disclosure can be useful in improving durability due to increase in quenchability since the grains are refined after the quenching with a double high frequency and coarsening of the grains is prevented even when the grains are overheated in a quenching process using the double high frequency, also useful in improving durability due to increases in strength, toughness, and corrosion resistance of the material since the grains are refined.

The drive shaft for a vehicle manufactured using the fine-grained alloy steel according to the exemplary embodiment of the present inventive concept has effects of improving durability of a vehicle and extending the lifespan thereof, thereby preventing environmental pollution.

As is apparent from the above description, the present disclosure provides a system for an overheating-insensitive fine-grained alloy steel for use in a double high-frequency heat treatment, and a method for manufacturing the same.

Although the exemplary embodiments of the present inventive concept have been disclosed for illustrative purposes, those skilled in the art will appreciate that various modifications, additions, and substitutions are possible, without departing from the scope and spirit of the invention as disclosed in the accompanying claims.

What is claimed is:

1. A fine-grained alloy steel comprising iron (Fe) as a main component, and 0.40 to 0.55% by weight of carbon (C), 0.20 to 0.40% by weight of silicon (Si), 0.8 to 1.0% by weight of manganese (Mn), 0.8 to 1.2% by weight of chromium (Cr), 0.045% by weight of aluminum (Al), and inevitable impurities, based on a total weight of the fine-grained alloy steel.

2. The fine-grained alloy steel according to claim 1, further comprising molybdenum (Mo),
wherein Mo is present at a content of 0.20 to 0.45% by weight based on the total weight of the fine-grained alloy steel.

3. The fine-grained alloy steel according to claim 1, further comprising titanium (Ti),
wherein Ti is present at a content of 0.030% by weight based on the total weight of the fine-grained alloy steel.

4. The fine-grained alloy steel according to claim 1, further comprising niobium (Nb),
wherein Nb is present at a content of 0.025 to 0.05% by weight based on the total weight of the fine-grained alloy steel.

5. The fine-grained alloy steel according to claim 1, further comprising boron (B),
wherein B is present at a content of 0.0020 to 0.0040% by weight based on the total weight of the alloy steel.

6. The fine-grained alloy steel according to claim 1, further comprising Mo, Ti, Nb, and boron (B),
wherein Mo is present at a content of 0.20 to 0.45% by weight, Ti is present at a content of 0.030% by weight, Nb is present at a content of 0.025 to 0.05% by weight, and B is present at a content of 0.0020 to 0.0040% by weight, based on the total weight of the fine-grained alloy steel.

7. The fine-grained alloy steel according to claim 6, wherein C, Si, Mn, Cr, Mo, Al, Ti, and Nb have a refinement correlation index F of 8.5 to 12, as follows:
F=10×[C]+0.33×[Si]+0.2×[Mn]+0.7×([Cr]+[Mo])+0.5×([Ti]+[Al]+[Nb]),
wherein [C] is 0.54×(C content (% by weight)) where a content of C is greater than 0% by weight and less than or equal to 0.39% by weight,
0.115+0.268×(C content (% by weight))−0.038×(C content (% by weight))² where the C content is greater than 0.39% by weight and less than or equal to 0.55% by weight,
0.115+0.268×(C content (% by weight))−0.038×(C content (% by weight))² where the C content is greater than 0.55% by weight and less than or equal to 0.65% by weight,
0.143+0.2×(C content (% by weight)) where the C content is greater than 0.65% by weight and less than or equal to 0.75% by weight, and
0.062+0.409×(C content (% by weight))−0.135×(C content (% by weight))² where the C content is greater than 0.75% by weight and less than or equal to 0.9% by weight;
[Si] is 1+0.7×(Si content (% by weight)) where a content of Si is greater than 0% by weight and less than or equal to 0.4% by weight;
[Mn] is 1.3333+(Mn content (% by weight)) where a content of Mn is greater than 0% by weight and less than or equal to 0.8% by weight,
wherein 3.3333×(Mn content (% by weight))₊1 where the Mn content is greater than 0.8% by weight and less than or equal to 1.0% by weight, and
2.1×(Mn content (% by weight))−1.12 where the Mn content is greater than 1.0% by weight and less than or equal to 1.95% by weight;
[Cr] is 1+2.16×(Cr content (% by weight)) where a content of Cr is greater than 0% by weight and less than or equal to 2.0% by weight;
[Mo] is 1 where a content of Mo is greater than 0% by weight and less than 0.2% by weight,
wherein 1+3×(Mo content (% by weight)) where the Mo content is greater than or equal to 0.2% by weight and less than or equal to 1.0% by weight;
[Ti] is 145×(Ti content (% by weight)) where a content of Ti is greater than 0% by weight and less than or equal to 0.03% by weight,
wherein 4.35 the Ti content is greater than 0.03% by weight;
[Al] is 1.73×(Al content (% by weight)) where a content of Al is greater than 0% by weight and less than or equal to 0.05% by weight; and
[Nb] is 1+0.363×(Nb content (by weight)) where a content of Nb is greater than 0% by weight and less than or equal to 0.05% by weight.

8. A method of manufacturing a fine-grained alloy steel, the method comprising:
mixing C, Si, Mn, Cr, Mo, Al, Ti, and Nb of an alloy steel to prepare a source material;
heating the alloy steel;
hot-forging the heated alloy steel;
quenching and tempering the hot-forged alloy steel; and
heat-treating the quenched and tempered alloy steel with a high frequency,
wherein C, Si, Mn, Cr, Mo, Al, Ti, and Nb have a refinement correlation index F of 8.5 to 12, as follows:
F=10×[C]+0.33×[Si]+0.2×[Mn]+0.7×([Cr]+[Mo])+0.5×([Ti]+[Al]+[Nb]),
wherein [C] is 0.54×(C content (% by weight)) where a content of C is greater than 0% by weight and less than or equal to 0.39% by weight,
0.115+0.268×(C content (% by weight))−0.038×(C content (% by weight))² where the C content is greater than 0.39% by weight and less than or equal to 0.55% by weight,
0.115+0.268×(C content (% by weight))−0.038×(C content (% by weight))² where the C content is greater than 0.55% by weight and less than or equal to 0.65% by weight,
0.143+0.2×(C content (% by weight)) where the C content is greater than 0.65% by weight and less than or equal to 0.75% by weight, and
0.062+0.409×(C content (% by weight))−0.135×(C content (% by weight))² where the C content is greater than 0.75% by weight and less than or equal to 0.9% by weight;
[Si] is 1+0.7×(Si content (% by weight)) where a content of Si is greater than 0% by weight and less than or equal to 0.4% by weight;
[Mn] is 1.3333+(Mn content (% by weight)) where a content of Mn is greater than 0% by weight and less than or equal to 0.8% by weight,
wherein 3.3333×(Mn content (% by weight))₊1 where the Mn content is greater than 0.8% by weight and less than or equal to 1.0% by weight, and
2.1×(Mn content (% by weight))−1.12 where the Mn content is greater than 1.0% by weight and less than or equal to 1.95% by weight;
[Cr] is 1+2.16×(Cr content (% by weight)) where a content of Cr is greater than 0% by weight and less than or equal to 2.0% by weight;
[Mo] is 1 where a content of Mo is greater than 0% by weight and less than 0.2% by weight,
wherein 1+3×(Mo content (% by weight)) where the Mo content is greater than or equal to 0.2% by weight and less than or equal to 1.0% by weight;
[Ti] is 145×(Ti content (% by weight)) where a content of Ti is greater than 0% by weight and less than or equal to 0.03% by weight,
wherein 4.35 the Ti content is greater than 0.03% by weight;
[Al] is 1.73×(Al content (% by weight)) where a content of Al is greater than 0% by weight and less than or equal to 0.05% by weight; and
[Nb] is 1+0.363×(Nb content (by weight)) where a content of Nb is greater than 0% by weight and less than or equal to 0.05% by weight.

9. The method according to claim 8, further comprising friction-welding the quenched and tempered alloy steel after the step of quenching and tempering.

10. The method according to claim 8, wherein the step of quenching and tempering comprises:
quenching the hot-forged alloy steel with a first high frequency;
quenching the hot-forged alloy steel with a second high frequency; and
tempering the hot-forged alloy steel.

11. The method according to claim 10, wherein the step of quenching with the first high frequency is performed at a current of 310 A to 410 A, a voltage of 270 V to 370 V, and a frequency of greater than 0 kHz to 5 kHz, and
the step of quenching with the second high frequency is performed at a current of 310 A to 410 A, a voltage of 270 V to 370 V, and a frequency of 30 kHz to 50 kHz.

12. The method according to claim 10, wherein the step of tempering is performed at a tempering holding temperature of 180° C. for a heat treatment time of 3 hours.

13. A hollow drive shaft for a vehicle manufactured using a method of manufacturing a fine-grained alloy steel, wherein the method includes: mixing C, Si, Mn, Cr, Mo, Al, Ti, and Nb of an alloy steel to prepare a source material; heating the alloy steel; hot-forging the heated alloy steel; quenching and tempering the hot-forged alloy steel; and heat-treating the quenched and tempered alloy steel with a high frequency, and
wherein C, Si, Mn, Cr, Mo, Al, Ti, and Nb have a refinement correlation index F of 8.5 to 12, as follows:
F=10×[C]+0.33×[Si]+0.2×[Mn]+0.7×([Cr]+[Mo])+0.5×([Ti]+[Al]+[Nb]), wherein [C] is 0.54×(C content (% by weight)) where a content of C is greater than 0% by weight and less than or equal to 0.39% by weight, 0.115+0.268×(C content (% by weight))−0.038×(C content (% by weight))² where the C content is greater than 0.39% by weight and less than or equal to 0.55% by weight, 0.115+0.268×(C content (% by weight))−0.038×(C content (% by weight))² where the C content is greater than 0.55% by weight and less than or equal to 0.65% by weight, 0.143+0.2×(C content (% by weight)) where the C content is greater than 0.65% by weight and less than or equal to 0.75% by weight, and
0.062+0.409×(C content (% by weight))−0.135×(C content (% by weight))² where the C content is greater than 0.75% by weight and less than or equal to 0.9% by weight;
[Si] is 1+0.7×(Si content (% by weight)) where a content of Si is greater than 0% by weight and less than or equal to 0.4% by weight;
[Mn] is 1.3333+(Mn content (% by weight)) where a content of Mn is greater than 0% by weight and less than or equal to 0.8% by weight, wherein 3.3333×(Mn content (% by weight))+1 where the Mn content is greater than 0.8% by weight and less than or equal to 1.0% by weight, and 2.1×(Mn content (% by weight))−1.12 where the Mn content is greater than 1.0% by weight and less than or equal to 1.95% by weight;
[Cr] is 1+2.16×(Cr content (% by weight)) where a content of Cr is greater than 0% by weight and less than or equal to 2.0% by weight;
[Mo] is 1 where a content of Mo is greater than 0% by weight and less than 0.2% by weight, wherein 1+3×(Mo content (% by weight)) where the Mo content is greater than or equal to 0.2% by weight and less than or equal to 1.0% by weight;
[Ti] is 145×(Ti content (% by weight)) where a content of Ti is greater than 0% by weight and less than or equal to 0.03% by weight, wherein 4.35 the Ti content is greater than 0.03% by weight;
[Al] is 1.73×(Al content (% by weight)) where a content of Al is greater than 0% by weight and less than or equal to 0.05% by weight; and
[Nb] is 1+0.363×(Nb content (by weight)) where a content of Nb is greater than 0% by weight and less than or equal to 0.05% by weight.
